(19) United States
(12) Patent Application Publication
(10) Pub. No.: US 2015/0118032 A1
(43) Pub. Date: Apr. 30, 2015

(54) SEAL SYSTEM

(71) Applicants: Emil Aschenbruck, Duisburg (DE); Carsten Bennewa, Oberhausen (DE)

(72) Inventors: Emil Aschenbruck, Duisburg (DE); Carsten Bennewa, Oberhausen (DE)

(73) Assignee: MAN Diesel & Turbo SE

(21) Appl. No.: 14/521,025

(22) Filed: Oct. 22, 2014

(30) Foreign Application Priority Data
Oct. 24, 2013 (DE) DE102013017710.3

(51) Int. Cl. F01D 11/02; F01D 11/08

(52) U.S. Cl. CPC F01D 11/025; F01D 11/08; F05D 2260/941; F05D 2240/56
USPC 415/173.5

(57) ABSTRACT

A seal system for sealing a seal gap in a turbomachine includes: a rotor component; a stator component, the sealing gap extending between the rotor component and the stator component; first seal strips and second seal strips each projecting into the seal gap and forming at least one seal strip package; first seal strip grooves in the rotor component that receive the first seal strips; second seal strip grooves in the stator component that receive the second seal strips; and a relief groove in the rotor component arranged in front of the seal strip package, and after the seal strip package. Every relief groove is at least two times wider than, and at most six times wider than, the first and second seal strip grooves and at least two times deeper than, and at most six times deeper than, the first and second seal strip grooves.

### BACKGROUND OF THE INVENTION

1. Field of the Invention

The invention is directed to a seal system for a turbomachine and to a turbomachine.

2. Description of the Related Art

The publication “Heavy-Duty Steam Power Plants [Groβe Dampfkraftwerke]”, Volume III B, Springer Verlag, pages 68 and 69, discloses a seal system for sealing a seal gap between a rotor-side component of a turbomachine and a stator-side component of the turbomachine, wherein a plurality of seal strip grooves in which first seal strips are received are incorporated in the rotor-side component, and wherein a plurality of seal strip grooves in which second seal strips are received are incorporated in the stator-side component. The seal strips form a plurality of seal strip packages. Further, it is known in this prior art to incorporate relief grooves in the rotor-side component, namely, between all of the adjacent rotor-side seal strip grooves within a seal strip package, which relief grooves are aligned with the second seal strips associated with the stator-side component. This prevents the second seal strips associated with the stator-side component from brushing into the rotor-side component in operation.

A further seal system for a turbomachine for sealing a seal gap between a rotor-side component of the turbomachine and a stator-side component of the turbomachine is known from DE 100 30 820 A1. It is also suggested in this prior art to incorporate at least one relief groove in the rotor-side component within a seal package, i.e., between adjacent seal strip grooves of the seal strip package, wherein the relief groove, or every relief groove, has a depth of between 25% and 50% of the depth of the seal strip grooves.

### SUMMARY OF THE INVENTION

Against this background, it is an object of the present invention to provide a novel seal system for a turbomachine and a novel turbomachine. This object is met by a seal system for a turbomachine in which a relief groove is incorporated in the rotor-side component in each instance exclusively in front of the seal strip package, or every seal strip package, and after the seal strip package, or every seal strip package, wherein every relief groove is at least two times wider than and at most six times wider than the seal strip grooves and, further, at least two times deeper than and at most six times deeper than the seal strip grooves. No relief grooves are incorporated in the rotor-side component within the seal strip package, or every seal strip package, between directly adjacent seal strips. As a result of the inventive positioning of the relief grooves and the inventive dimensioning of the relief grooves, a particularly advantageous seal system is provided for sealing a seal gap between a rotor-side component of a turbomachine and a stator-side component of a turbomachine. The arrangement and dimensioning of the relief grooves ensures that a warpage of the rotor-side component due to the action of heat is kept to a minimum even if unfavorable material couples between the rotor-side component and the stator-side component. Therefore, a very small clearance can be adjusted between the rotor-side component and the stator-side component. Starting of the turbomachine is assured even in case of such small clearance.

According to an advantageous further development, every relief groove is at least three times wider than, and at most five times wider than, the rotor-side seal strip grooves and, further, at least three times deeper than, and at most five times deeper than, the rotor-side seal strip grooves. In particular, every relief groove is about four times wider than the rotor-side seal strip grooves and, further, about four times deeper than the rotor-side seal strip grooves. This dimensioning of the relief grooves is particularly advantageous.

According to an advantageous further development, the radial depth of every relief groove corresponds to the axial width thereof so that the relief grooves have a square cross-sectional surface in axial cross section. This geometric contouring of the relief grooves is particularly advantageous.

Other objects and features of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, it is merely intended to conceptually illustrate the structures and procedures described herein.

### BRIEF DESCRIPTION OF THE DRAWING

Preferred further developments of the invention are indicated in the following description. Without limiting generality, embodiment examples of the invention are described in more detail with reference to the drawing, in which:

FIG. 1 shows a detail of a turbomachine in the region of a seal system according to an embodiment of the invention.

### DETAILED DESCRIPTION OF THE PRESENTLY PREFERRED EMBODIMENTS

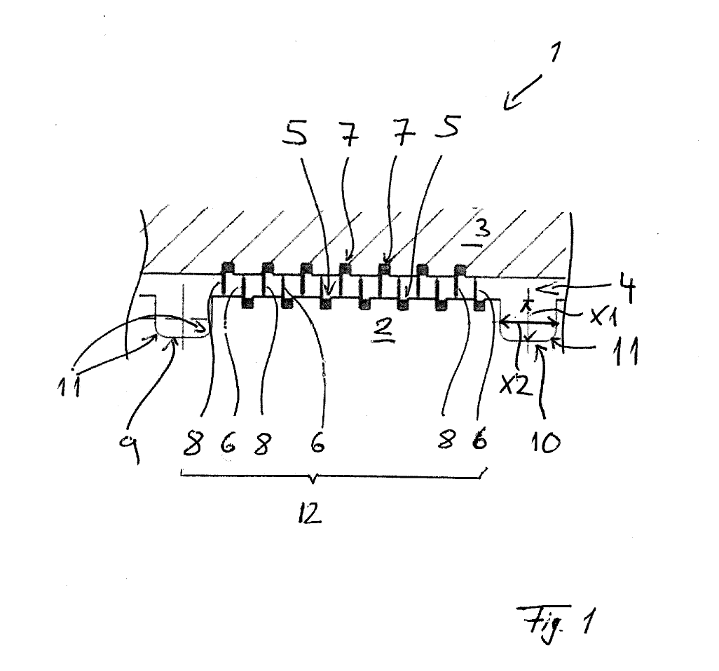

The FIG. 1 shows a detail of a turbomachine in the region of a seal system 1 according to an exemplary embodiment of the invention. Thus FIG. 1 shows a detail of a rotor-side component 2 of a turbomachine and a stator-side component 3 of the turbomachine, a seal gap 4 to be sealed being formed between these two components 2, 3. In particular, the rotor-side component 2 is a shaft of the turbomachine and the stator-side component 3 is a housing of the turbomachine. A plurality of seal strip grooves 5 are incorporated in the rotor-side component 2. A seal strip 6 is received in every seal strip groove 5 of the rotor-side component 2. Further, a plurality of seal grooves 7 in which a seal strip 8 is likewise received in each instance are incorporated in the stator-side component 3. The seal strips 6 arranged in the seal strip grooves 5 of the rotor-side component 2 project by free ends of seal strips 6 into the seal gap 4 and can brush into the stator-side component 3 with these ends in operation. The seal strips 8 arranged in seal strip grooves 7 of stator-side component 3 project into seal gap 4 with free ends of seal strips 8 and can brush into the rotor-side component 2 with these ends in operation.

In FIG. 1, seal strips 6, 8 form an individual seal strip package 12. In contrast, however, it is also possible that seal strips 6, 8 are grouped to form a plurality of seal strip packages 12.

In the exemplary embodiment in FIG. 1, relief grooves 9, 10 are incorporated in the rotor-side component 2 within the meaning of the present invention. Namely, viewed in through-flow direction of the seal gap 4 to be sealed, a first relief groove 9 is provided in front of the seal strip package 12 and a second relief groove 10 is provided after the seal strip package 12 so that, consequently, no relief grooves are incorporated in the rotor-side component 2 between directly adjacent rotor-side seal strip grooves 5 within the seal strip package 12 shown in FIG. 1. Consequently, the seal strips 6 arranged in the seal strip grooves 5 of the rotor-side component 2 can brush into the stator-side component 3 on the one hand, and the seal strips 8 arranged in the seal strip grooves 7 of the stator-side component 3 can brush into the rotor-side component 2 on the other hand. This is advantageous for an efficient sealing of the seal gap 4.

The relief grooves 9, 10 incorporated in the rotor-side component 2 in front of and after the seal strip package 12 shown in FIG. 1 are at least two times wider than, and at most six times wider than, seal strip grooves 5, 7 and, further, at least two times deeper than, and at most six times deeper than, seal strip grooves 5, 7. A risk of warpage of the rotor-side component 2 due to action of heat as the seal strips 8 associated with the stator-side component 3 run in or brush in is minimized as a result of this dimensioning and arrangement of the relief grooves 9, 10, while ensuring a good sealing function and providing a minimum clearance between the rotor-side component 2 and the stator-side component 3. The risk of damage to the rotor-side component 2 is reduced.

Each of the relief grooves 9, 10 is preferably at least three times wider than, and at most five times wider than, and at least three times deeper than, and at most five times deeper than, each of the seal grooves 5 incorporated in the rotor-side component 2. In a particularly preferred embodiment of the invention, each of the relief grooves 9 incorporated in the rotor-side component 2 is about four times wider than, and about four times deeper than, the seal strip grooves 5 incorporated in the rotor-side component 2. “About four times” corresponds to a range of between 3.6 times and 4.4 times, i.e., four times ±10%.

The relief grooves 9, 10 incorporated in the rotor-side component 2 are preferably square in cross section and are accordingly geometrically contoured such that the radial depth thereof corresponds approximately to the axial width thereof. In FIG. 1, the radial depth is illustrated by dimension X1 and the axial width is illustrated by dimension X2. The relief grooves 9 have rounded corners 11 in the region of a groove base.

The relief grooves 9, 10 allow an axial expansion of the rotor-side component 2 when the seal strips 8 associated with the stator-side component 3 brush into or run against the radial component 2, so that a warpage of the rotor-side component 2 can at least be minimized even if unfavorable material couples between the rotor-side component 2 and the stator-side component 3. Accordingly, the relief grooves 9, 10 can absorb or compensate axial elongation of the rotor-side component 2 occurring during the brushing in of the stator-side seal strips 8 in order to prevent a curvature of the rotor-side component 2. Further, the relatively deep relief grooves 9, 10 advantageously influence the rotor dynamics through the reduction of the rotor cross section achieved in this way in the region of relief grooves 9, 10. It is possible for the turbomachine to be started at any time. Beyond this, the seal system 1 ensures an efficient sealing of the seal gap 4 to be sealed.

The seal system 1 according to the invention is used in turbomachines. In particular, the seal system 1 according to the invention is used in axial flow machines, preferably in an axial flow turbine or axial flow expander. However, the seal system 1 according to the invention can also be used in an axial flow compressor or in a radial-axial flow machine.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A seal system (1) for sealing a seal gap (4) in a turbomachine, comprising:
a rotor component (2) having a longitudinal extent;
a stator component (3) having a longitudinal extent, the sealing gap (4) extending between the respective longitudinal extents of the rotor component (2) and the stator component (3);
first seal strips (6) projecting into the seal gap (4);
second seal strips (8) projecting into the seal gap (4), wherein the first and second seal strips (6, 8) form at least one seal strip package (12);
a plurality of first seal strip grooves (5) in the rotor component (2) that receive the first seal strips (6);
a plurality of second seal strip grooves (7) in the stator component (3) that receive the second seal strips (8); and
a relief groove (9, 10) in the rotor component (2) in each instance being arranged exclusively in front of the seal strip package (12), or in front of every seal strip package (12), and after the seal strip package (12), or after every seal strip package (12),
wherein every relief groove (9, 10) is at least two times wider than, and at most six times wider than, the first and second seal strip grooves (5, 7) and, further, at least two times deeper than, and at most six times deeper than, the first and second seal strip grooves (5, 7).

2. The seal system according to claim 1, wherein no relief grooves are arranged in the rotor component (2) within the seal strip package (12), or every seal strip package (12), between directly adjacent ones of the first seal strips (6).

3. The seal system according to claim 1, wherein every relief groove (9, 10) is at least three times wider than, and at most five times wider than, the first seal strip grooves (5) and, further, at least three times deeper than, and at most five times deeper, than the first seal strip grooves (5).

4. The seal system according to claim 3, wherein every relief groove (9, 10) is about four times wider than the first seal strip grooves (5) and, further, about four times deeper than the first seal strip grooves (5).

5. The seal system according to claim 1, wherein the radial depth of every relief groove (9, 10) corresponds to its axial width so that the relief grooves (9, 10) have a square cross-sectional surface in axial cross section.

6. The seal system according to claim 5, wherein the square cross-sectional surface of every relief groove (9, 10) has rounded corners (11) in a base of the groove.

7. The seal system according to claim 1, wherein free ends of the first seal strips (6) brush into the stator component (3), and free ends of the second seal strips (8) brush into the rotor component (2).

8. A turbomachine comprising the seal system (1) according to claim 1.

9. The turbomachine according to claim 8, wherein the turbomachine is an axial flow turbine.
